(19) United States
(12) Patent Application Publication
(10) Pub. No.: US 2011/0191676 A1
(43) Pub. Date: Aug. 4, 2011

(54) Cross-Browser Interactivity Recording, Playback, and Editing

(75) Inventors: Steve Guttman, Mercer Island, WA (US); Michael Fanning, Redmond, WA (US); Matt Hall, Seattle, WA (US)

(73) Assignee: MICROSOFT CORPORATION, Redmond, WA (US)

(21) Appl. No.: 12/696,187

(22) Filed: Jan. 29, 2010

(51) Int. Cl. G06F 3/00; G06F 3/048

(52) U.S. Cl. 715/716; 715/768

(57) ABSTRACT

Multi-browser interactivity testing records user interactions with a recorder browser for subsequent playback in one or more player browsers. User input to the recorder browser directed at a Document Object Model element is intercepted, and the input and element are noted in an interaction record. After reading the interaction record in a player browser, a corresponding element is located, using attribute values or other mechanisms. The user input is applied to the located player element(s) by simulated system level events, and the results are displayed. Player browser playback can be synchronized with screenshots or video clips of the recorder browser. The interaction recording can also be edited. Layout which depends on interactive behaviors such as login or accordion controls, and other aspects of interactivity, can be tested without manually repeating the input for each browser, and despite differences in the layout engines.

### BACKGROUND

Browsers are perhaps most familiar as tools for retrieving, presenting, and navigating web pages in the World Wide Web. Web pages may contain text, still images, video, audio, and interactive content. Browsers can also be used to access information provided by servers or peers in private networks, or in local files on a particular computer, smart phone, or other device.

A wide variety of browsers can be found in service. For example, different versions of Microsoft® Internet Explorer® browsers exist, with different capabilities (Internet Explorer® is a mark of Microsoft Corporation). Although the Internet Explorer® browser is widely used, many other browsers are also used, on computers, on phones, in cars, and in other devices. Browsers differ in characteristics such as the operating system(s) they run under, the layout engines they use to translate web page objects into visual displays, the mechanisms they use to accept user input, which features they implement natively (without plug-ins or other extensions), and which web standards and protocols they support, for example.

### SUMMARY

Browsers differ in how they render images, make page layouts, and generate page interactivity for users. To enhance or supplement technologies for testing interactive screen layout in different browsers, some embodiments described herein support cross-browser interactivity recording, playback, and editing. For instance, a sequence of interactions with one kind of browser in one machine configuration can be recorded at a Document Object Model (DOM) tree element level, and be played back at that level in a different kind of browser and/or in a browser running in a different machine configuration. User-browser interaction records can be used to identify and explore differences in behavior based on JavaScript® code or Cascading Style Sheet code, different hardware, and different operating systems, for example. (JavaScript® is a mark of Sun Microsystems, Inc.)

Some embodiments support browser interactivity recording with a computer, smart phone, or other device that has a display, a processor, and memory. User input to a recorder browser is intercepted, by a mechanism such as a transparent window or an event handler. A pertinent element is identified, namely, a Document Object Model element in the recorder browser which is configured to respond to the intercepted user input. A user-browser interaction record which specifies the pertinent element and the user input is created and recorded. The interaction record may also be associated with a screenshot or video clip of interaction(s) with the recorder browser; a video clip may include marker frames synchronizing it with the user input to Document Object Model elements.

Some embodiments support browser interactivity playback at the DOM tree element level. For example, interactivity testing code reads a user-browser interaction record and locates, among a player browser's Document Object Model elements, an element corresponding to the element specified in the user-browser interaction record. The interaction record may have been created using the same browser, but it may also have been created from a different kind of browser, possibly in a different machine configuration. That is, the recorder browser and the player browser need not be the same browser, or the same kind of browser, or even be browsers in the same machine configuration. They will simply have the same web page DOM elements loaded. The user input is applied to the located DOM element in the player browser. Playback may be paused, reversed, and/or synchronized with still or video clips of the recorder browser interaction(s). Multiple player browsers may run a given sequence of interaction records, one after another or at the same time, on the same or different machines.

Some embodiments support browser interactivity editing and inspection. For example, Document Object Model elements may be interrogated and modified while recording/playback is frozen. Scripting language statements may also be inserted in a sequence of interaction records, and some embodiments allow editing to insert a sequence of statements that call methods exposed by the Document Object Model elements. In some embodiments, a player browser can be placed in a specified state by loading a previously stored DOM tree state rather than interpreting a sequence of user-browser interaction records to reach the specified state.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer or other device having at least one processor, at least one memory, at least one browser, and other items in an operating environment which may be present on multiple network nodes, and also illustrating configured storage medium embodiments;

FIG. 2 is a block diagram illustrating a recorder browser, player browser(s), interactivity testing code, user-browser interaction records, and other components in an example architecture for some embodiments;

FIG. 3 is a block diagram illustrating mechanisms for intercepting user input, applying user input, and/or otherwise managing user input in some embodiments;

FIG. 4 is a diagram representing a screen having one region allocated to a recorder browser and another region allocated to a player browser during interactivity testing in some embodiments;

FIG. 5 is a block diagram illustrating an embodiment in which a recorder browser resides on one device, and three player browsers reside respectively on three other devices, with the devices connected by a network;

FIG. 6 is a block diagram illustrating normalized records of user-browser interaction in some embodiments;

FIG. 7 is a flow chart illustrating some steps of method and configured storage medium embodiments for recording interactivity, as well as other purposes;

FIG. 8 is a flow chart illustrating some steps of method and configured storage medium embodiments for playing back interactivity recordings, as well as other purposes; and

FIG. 9 is a data flow diagram illustrating some embodiments.

### DETAILED DESCRIPTION

Overview

During the development of web pages, significant effort may be spent to ensure that web pages will function similarly in a wide variety of browsers, including for example multiple versions of Microsoft Internet Explorer® software, Firefox® software, and Safari® software (marks of Microsoft Corporation, Mozilla Foundation, and Apple, Inc., respectively). While several solutions exist for statically testing whether the layout of elements on a page match in different browsers, solutions for testing cross-browser interactivity such as JavaScript® code behaviors and animations, as well as Cascading Style Sheet (CSS) code behaviors, have been lacking.

One may divide familiar solutions to cross-browser layout into two groups. One group includes layout solutions such as the Adobe® BrowserLab service and the Microsoft® Expression Web SuperPreview tool. These solutions allow a user to verify the layout of page elements in multiple browsers by essentially taking pictures of pages and allowing users to compare those pictures and identify which elements are the same (or different) in order to help diagnose why they are different. In this group, the solutions provide static pictures, possibly supplemented by element information. Interactive behaviors are not adequately explored, if at all, by such solutions.

A second group includes layout solutions such as the IETester tool. These solutions merely host multiple browsers in a side-by-side fashion, allowing a user to test a sequence of operations in one browser, and then conveniently switch to another browser to test the same sequence. The IETester tool allows developers to access multiple, incompatible versions of Internet Explorer® software. However, this second group of layout software does not provide the ability to simultaneously test multiple browsers.

Another known technology is “co-browsing” whereby users install a special client (usually a browser plug-in) on their machines. Browsers are placed in a master-slave relationship during co-browsing, such that a slave browser will automatically go to a destination set in a master browser. However, co-browsing merely synchronizes web page destinations, not the user actions and page behaviors within a destination web page. Pixel-based recordings of browsers, such as screenshots and video clips, are also known.

By contrast, some embodiments described herein support cross-browser interactivity testing, through cross-browser page visualization generation and cross-browser page visualization presentation, for example, and more. Some embodiments provide a mechanism for simultaneously testing web page interactivity (animations, behaviors, programmatic response) by playing back user-browser interaction records in multiple web browsers. A user interacts directly with a recorder browser, and the recorded interactions (clicks, mouse-overs and other gestures) with page elements are mapped to the corresponding page elements in one or more player browsers. Player browsers can be located on the same machine and even hosted within the same interface as the recorder browser, or players can be located on different physical CPUs than the recorder. In some configurations, one or more players are on the same machine as the recorder, and other players of that same recording are on different machine(s).

Cross-browser interactivity is also discussed in a U.S. patent application titled “Cross-Browser Interactivity Testing”, Ser. No. 12/686,436 filed Jan. 13, 2010, having the same inventors as the present application. The Ser. No. 12/686,436 application is incorporated herein by reference in its entirety and made part of the present disclosure. Any terminology or other conflict between the applications herein is to be resolved in favor of supporting the present application and its claims.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

Throughout this document, use of the optional plural “(s)” means that one or more of the indicated feature is present. For example, “browser(s)” means “one or more browsers” or equivalently “at least one browser”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

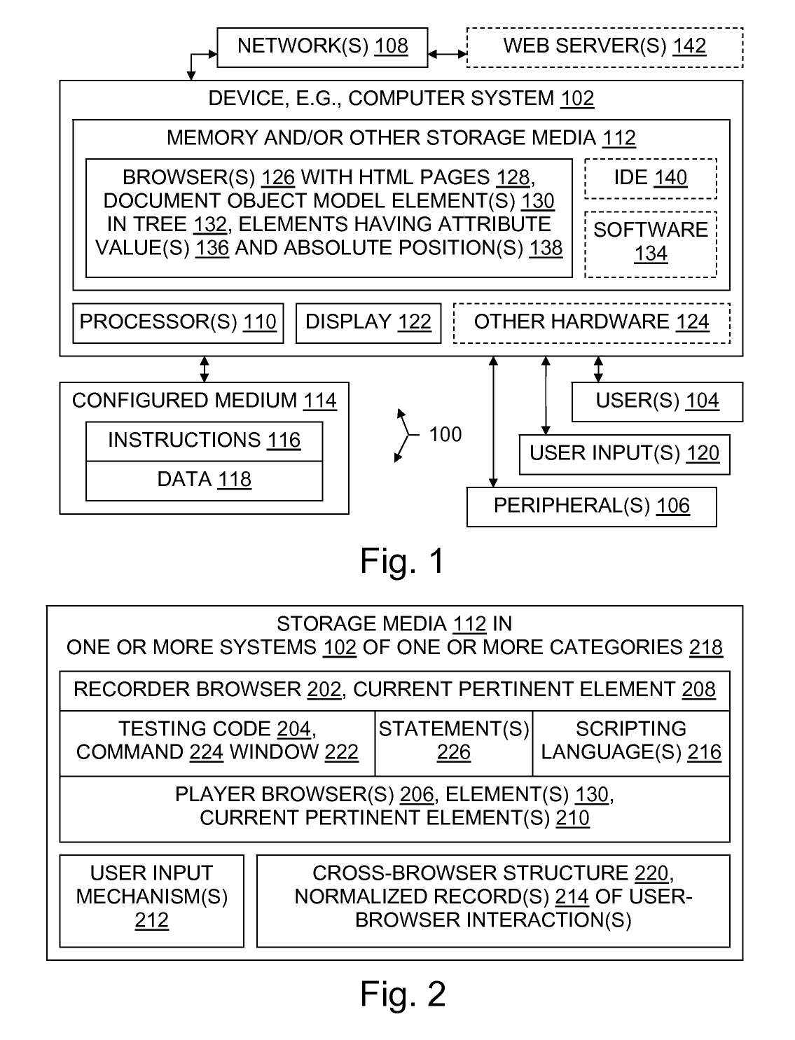

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106, e.g., to request web pages 128 from web server(s) 142. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example. During interactions, users provide input(s) 120 through keyboards, mice, and other peripherals 106, and/or through network 108 connection(s), and users receive output data through a display 122, other hardware 124, and/or network connection, for example.

The computer system 102 includes at least one logical processor 110. The computer system 102, like other suitable systems, also includes one or more computer-readable non-transitory storage media 112. The media 112 may be volatile memory, non-volatile memory, fixed in place media, removable media, magnetic media, optical media, and/or of other types of non-transitory media (as opposed to transitory media such as a wire that merely propagates a signal). Media 112 may be of different physical types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed as discussed herein, e.g., by mapping, interception, execution, suspension, interrogation, modification, display, creation, loading, and/or other operations.

One or more web browsers 126 with HTML pages(s) 128 and corresponding Document Object Model (DOM) element(s) 130 in one or more DOM trees 132, other software 134, and other items shown in the Figures may reside partially or entirely within one or more media 112, thereby configuring those media. Elements 130, sometimes also referred to as objects, may have associated attribute value(s) 136. Displayable elements 130 generally have respective position(s) 138, such as position(s) relative to some viewport origin. In some cases, the position of an element depends on the width of the browser window, and the browser rendering engine, as well. In addition to processors 110, optional peripheral(s) 106, media 112, and an optional display 122, an operating environment may also include other hardware 124, such as buses, power supplies, and accelerators, for instance.

A given operating environment 100 may include an Integrated Development Environment (IDE) 140 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development per se that use browsers.

Some items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments. A recorder browser 202 receives input which is mapped at the element 130 level by interactivity testing code 204 to provide corresponding interaction with one or more player browsers 206. In particular, a pertinent recorder element 208, which is an element 130 in a recorder browser, at which specified user input 120 is directed, is mapped to a corresponding pertinent player element 210, and the user input is applied to the pertinent player element(s) to test their interactive behavior under the guidance of simulations of the input directed at the recorder browser. Mechanisms 212 for intercepting, blocking, applying, simulating, and otherwise managing user input are provided in various embodiments discussed herein.

Some embodiments create normalized records 214 of user interaction with the recorder browser, and some embodiments control player browser behavior by reading and acting upon these normalized records 214 of user-browser interaction. Normalized records 214 are also referred to as user-browser interaction records 214. A cross-browser structure 220, such as a list, table, array, tree, encoding, and/or file, can hold a sequence of one or more interaction records 214.

In some embodiments, interactive behavior of scripting language 216 code (e.g., JavaScript® code) in web pages can be tested. A user directs a sequence of user inputs 120 at a recorder browser, and the testing code 204 automatically maps those inputs through pertinent recorder elements to pertinent player elements, and records the inputs and elements in records 214. The testing code also automatically reads the records 214 and applies the inputs to the pertinent player elements, so browser scripting language behavior and other behaviors can be tested in multiple player browsers on one or more machines, without requiring a user to repeat the input into each browser manually or use a test-scenario-specific script for each test sequence and each browser.

In some embodiments, interactivity testing code 204 provides users with a command window 222 allowing entry of live or scripted commands 224. For example, scripting language statements 226 and/or statements 226 invoking methods on DOM tree elements may be entered as commands. Commands 224 may also be used to load DOM tree state from a recording, to step through user- browser interaction records 214 and apply inputs to elements, to reverse the order in which records 214 are thus interpreted, to pause interpretation of records 214, and so on. Commands 224 may also be used to save or retrieve live views, screenshots, or video clips which can be synchronized with interpretation of particular records 214 by marker frames that associate records 214 with video or still images. Some embodiments can inspect and/or change the state of either DOM elements (e.g. change a style attribute on a DOM element) or a JavaScript® variable, and can propagate such changes across the player browser and reader browser instances.

A given embodiment may include one or more systems 102 (a.k.a. devices, machines) of one or more types. For example, a system 102 may be viewed as belonging to one or more of the following device categories 218: workstation devices (e.g., desktop computers, server computers), portable devices (e.g., laptop computers), embedded devices (e.g., systems embedded in automotive, aerospace, marine, and other vehicles), and phone devices (e.g., sell phones, smart phones). The interactivity testing code is not necessarily implemented in every available device category; the categories used may vary between embodiments.

DOM elements are associated with a specific web page. That is, a particular web page will be loaded into a recorder browser 202, and the records 214 will reference that web page's elements 130. The same web page (to the extent web pages loaded into different browsers are the same) will be loaded into the player browser(s) 206 so play playback of the records 214 can apply the inputs to the same DOM elements. For example, some embodiments capture destination URLs for operations that result in navigation to a new page. This data may be used for forcing a re-sync between browsers when DOM element reconciliation has otherwise failed. Thus, if a user clicked on an element in a recorder browser and this resulted in a navigate to another page, an embodiment can fallback to navigating to that destination in the event that it fails to locate a corresponding element to click in a player browser. Forcing all browsers to a common URL is a user operation that could be performed explicitly. Some embodiments support such navigation, or another specified fallback result or operation that is associated with an interaction record, in case locating and applying steps discussed below fail in a player browser.

With reference to FIGS. 1 and 2, some embodiments provide a cross-browser interactivity testing system including a computer system 102 or other device with a logical processor 110 and a memory medium 112 configured by circuitry, firmware, and/or software to transform input directed by a user at a recorder browser into records 214 of element-level-corresponding simulated input in one or more player browsers as described herein. A recorder browser 202 having Document Object Model elements 130 of a web page 128 resides in a local memory (RAM and/or another memory medium). A cross-browser structure 220 resides in at least one local memory. The cross-browser structure includes at least one record 214 and thus specifies a Document Object Model element 130 and a user input 120. Interactivity testing code 204 resides in at least one local memory. The interactivity testing code is configured to locate, among the browser Document Object Model elements, an element corresponding to the element specified in the cross-browser structure, and is also configured to apply the user input to the located element. The code also stores records 214 specifying the element and the user input, so the same interaction can be applied in player browser(s). The cross-browser structure could reside on disk, and be pulled into memory in a step-by-step fashion, e.g., one record 214 at a time.

In some embodiments, the cross-browser structure 220 specifies a plurality of Document Object Model elements 130 with corresponding user inputs 120. In some embodiments, the cross-browser structure includes in record(s) 214 the following for at least one of the Document Object Model elements: an object name of the element (a.k.a. herein as “tag name”), an element ID attribute value (or another element ID, namely, a way to uniquely identify the element within a SINGLE browser), a DOM tree position of the element. In some embodiments, the cross-browser structure record(s) 214 include the following for at least one of the user inputs: an action category of the user input, a coordinate position of the user input. Coordinate positions can either be relative to the page (viewport origin) or else relative to the object/DOM element the input is directed at.

In some embodiments, the system includes a sequence of scripting language statements 226 residing in a local memory. The sequence contains statements which specify Document Object Model elements and corresponding user inputs, in a scripting language 216 such as JavaScript® (mark of Sun Microsystems), VBScript (mark of Microsoft Corporation), or ActionScript® (mark of Adobe Systems Inc.), for example. In some embodiments, the system includes a sequence of statements 226 that call methods exposed by the Document Object Model elements, in a scripting language or a lower-level language like C# or C++, for example.

In some embodiments, the interactivity testing code 204 includes a command window 222, and the interactivity testing code is configured to perform at least one of the following command window operations.

A Log command 224 logs live interactions into the cross-browser structure 220 by logging current user input and browser Document Object Model elements targeted by the user input.

An Edit command 224 makes a live edit in the browser Document Object Model elements and/or markup language based on scripting language and/or other statements 226.

A Mimic command 224 mimics a user input gesture, e.g., “click button foo”.

A Get-State command 224 retrieves web page state information, such as DOM tree elements, and/or other data associated with the web page, e.g., ‘what is the position of element x’, ‘capture screen and write to temp dir’.

A Select-Players command 224 limits execution of a command to a specified proper subset of a set of one or more player browsers 206 which are playing back a sequence of user-browser interaction records of a cross-browser structure. For instance, one might execute a command or alter state specific to only a single browser in order to bring it into line with other browsers.

Various record-playback commands 224 such as Pause, Reverse, Step, Fast Forward, and Play perform record-playback operations to control the interpretation in player browser(s) of interaction record(s) 214. For example, one might command a system to ‘pause 10 seconds’, ‘close all player windows’, and so on.

In some embodiments, the interactivity testing code 204 is configured to take a screenshot of the browser and/or to record a video of the browser as multiple user inputs are applied to multiple browser Document Object Model elements specified in the cross-browser structure. Some embodiments insert marker frames in a video of the browser, thereby synchronizing a video clip with local events such as an application of user input to a Document Object Model element. In addition to screenshots, or simply recording the interactions, some embodiments allow one to capture the page source at that point in time, or some other representation of the DOM, and/or to write arbitrary logging details.

In some embodiments, peripherals 106 such as human user I/O devices (screen, keyboard, mouse, tablet, microphone, speaker, motion sensor, etc.) will be present in operable communication with one or more processors 110 and memory. In particular, a cursor-positioning device may be present, such as a mouse, pen, trackball, stylus, fingertip-sensitive touch screen, etc. However, an embodiment may also be configured such that no human user 104 interacts directly with the embodiment; software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

In some embodiments, a multi-browser interactivity testing system includes at least one logical processor 110, and at least one local memory in operable communication with a logical processor. A recorder browser 202 having recorder Document Object Model elements 130 resides in a local memory. A player browser 206 having player Document Object Model elements 130 resides in a local memory. Interactivity testing code 204 resides in at least one local memory. That is, the recorder browser 202, player browser(s) 206, and interactivity testing code 204 may reside in one or more memories, in operable communication with one or more logical processors 110; in this context, “local” implies in the same device as a logical processor, as opposed to being in some other device. Unless otherwise indicated, a reference to a logical processor in a claim means one or more logical processors is present.

The interactivity testing code 204 is configured to locate, among the player Document Object Model elements, a pertinent player element which corresponds to a pertinent recorder element. The pertinent recorder element is a recorder Document Object Model element targeted by a user input to the recorder browser. The interactivity testing code 204 is also configured to apply the user input to the pertinent player element.

In some embodiments, for example, a portion of the interactivity testing code 204 resides with the recorder browser on a first machine, another portion of the interactivity testing code 204 resides with a player browser on a second machine, and a similar portion of the interactivity testing code 204 resides with another player browser on a third machine. As with other systems 102, a particular machine could be a uniprocessor device or a multicore device.

More generally, one or more player browsers may be present in a particular embodiment. In some embodiments, the recorder browser, the player browser, and the interactivity testing code all reside on the same device. In other embodiments, the recorder browser resides on a first device having a first logical processor and a first local memory, the player browser resides on a second device having a second logical processor and a second local memory, and at least a portion of the interactivity testing code resides on each of the devices. For example, some embodiments use browser(s) on an Apple® Macintosh or other OS X operating system machine and browser(s) on a Microsoft Windows XP® or other Microsoft Windows operating system machine, such that the recorder browser and at least one player browser are running and being tested under different operating systems.

In some embodiments, one or more player browsers are allowed. In some cases, though, the embodiment includes at least one additional pertinent player element in at least one additional player browser, and the interactivity testing code is configured to applying the user input to at least one of the additional pertinent player element(s). In such embodiments, two or more player browsers are present. For example, FIG. 5 illustrates an embodiment having three player browsers communicating with a recorder browser over a network.

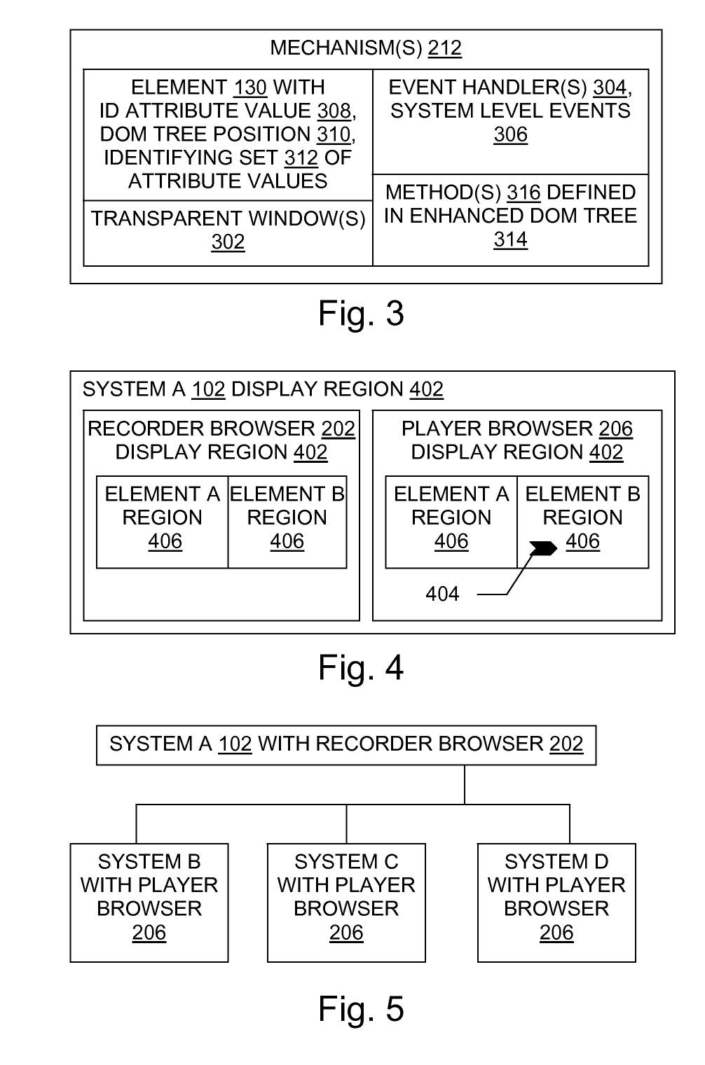

With regard to mechanisms 212 for managing user input, and with reference now to FIGS. 3 and 4 as well as FIGS. 1 and 2, some embodiments include a transparent window 302 positioned in front of a browser window or other display region 402. Using the transparent window, the interactivity testing code 204 intercepts signals from user input devices (peripherals 106), such as mouse, pen, and/or touch screens signals directed at the browser. Signals intercepted by a transparent window in front of a player browser may be discarded or passed to a pertinent element after interactivity analysis. In some situations the follower browser is not controlled by live direct input (user→follower browser) but instead receives its input via the leader (user→leader browser→system signals→follower browsers). An attempt to control a follower browser directly, instead of controlling the follower browser via the leader browser, can be blocked by discarding the direct input to the follower browser. In some situations a follower browser accepts input both directly and indirectly. In some situations, a signal intercepted by a transparent window (e.g., an invisible or hidden window) in front of a recorder browser may be analyzed to identify the pertinent recorder element 208 at which the signal was directed. In operation, some embodiments associate pertinent recorder elements and pertinent player elements by looking at the associated browser DOMs, which are not guaranteed to be identical. So one aspect of some embodiments is associating a recorder DOM element with the identical player element. Another method is to “hook” the window handle for the browser, which wouldn't require a transparent window. One would thus intercept all messages to the existing window at the Windows API level. More generally, some embodiments intercept user input events from the operating system before those events reach the browser itself.

In some embodiments, an element 130 such as a pertinent recorder element 208 and/or a pertinent player element 210, is specified with an element ID attribute value 308. Element ID attribute values need not necessarily be present on elements that do not serve as pertinent elements. Not all pertinent elements are necessarily provided with ID attributes in every page 128, so a pertinent element may also be specified in some cases by other mechanisms.

In some embodiments, for example, the element may be specified by its position 310 in the DOM tree. Position may be specified by listing a path from the root to the element. For instance, “113” could mean “start at root, follow leftmost link, follow leftmost link, follow third link from left, to arrive at element”. As another example, position could be specified by instructions to “Start at the root, traverse the first <div> element, traverse the second <div> within that element and choose the first <a> link.” Position may also be specified by listing the ordinal of the element in a particular traversal. For instance, “17” could mean “the element is the seventeenth element in a pre-order traversal starting at the root”.

In some embodiments, the element may be specified by a particular set 312 of style properties and/or attribute values 136. Element type may also be considered, e.g., a <ul> with rel=“contents” and solid 1px border style. For instance, the pertinent element may be the only element in the tree 132 which has both a Value1 attribute value and a Value2 attribute value.

In some embodiments, an event handler 304 simulates user input events by generating system level events 306. For example, interactivity testing code 204 on a player browser machine may receive a record 214 describing a user interaction the recorder browser, and then generate a system level event to cause a corresponding interaction with a pertinent player element.

In some embodiments, an event handler 304 is inserted in a page 128 in a browser using familiar DOM hooks. In some embodiments, an event handler 304 is inserted in a rewritten web page 128, that is, the HTML is modified by the testing code 204 to insert the event handler. In either case, the inserted event handler is normally not present in an original version of the web page 128 on a web server 142, and the event handler is configured to handle events caused by user input device signals.

In other words, the inserted event handler intercepts an event that would otherwise have gone to a different event handler, or would have gone nowhere (some events have no listeners). In the recorder browser, the page can be rewritten such that any element having an event handler Z also has the inserted handler 304 prepended to that event handler Z. The inserted handler 304 sends a message to interactivity testing code 204 that the event was triggered, and then passes the event through to the original event handler Z. The interactivity testing code 204 simulates the same event in the player browsers. Event handler insertion can be done without rewriting the web page; HTML DOM provides familiar mechanisms for hooking up event handlers without actually re-writing the source HTML.

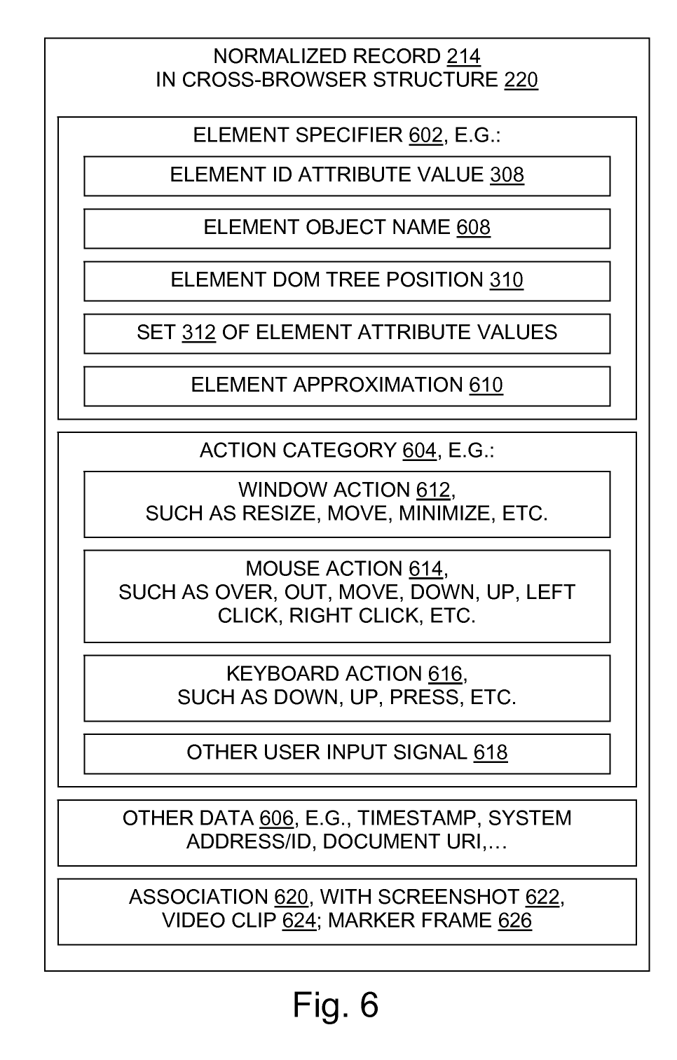

With particular reference to FIGS. 3 and 6, in some embodiments, a normalized record 214 of user interaction with the recorder browser 202 is used. The normalized record is also referred to as a user-browser interaction record 214. Record 214 resides in at least one local memory; a record 214 may be used to guide a player browser on the same machine as the recorder browser and/or may be transmitted over a network to a player browser on a remote machine. The normalized record includes an element specifier 602, an action category 604, and optionally includes other data 606 such as a timestamp, an address of other identifier of the recorder browser system, a URI or other address of the web page document that is loaded in the recorder browser, a checksum, and/or a digital signature, for example.

The element specifier 602 specifies pertinent elements. For instance, a pertinent element may be specified by an element ID attribute value 308, by an object name 608, by a DOM tree position 310, or by a set 312 of attribute values. In some cases, a pertinent element may not be specified as precisely and concisely as can be done with the foregoing, but can nonetheless be at least approximately specified. An element approximation 610 may be formed, for instance, as an assessment based on mouse coordinates and the distance to a center point of a display region whose width and height are known. Similarly, a rendered page can be partitioned into tiles according to DOM element display regions, and mouse coordinates can be used to approximately identify a pertinent element.

The action category 604 specifies user input device signal categories. Input may be treated as a window action 612, a mouse action 614, a keyboard action 616, or another kind of action signal 618, for instance.

Window actions 612 pertain to user actions on a browser interface window, such as actions to move the window's position on screen, to resize the window on screen, to minimize the window into a system tray, to maximize the window's area on screen, and so on.

Mouse actions 614 may pertain to user actions made with a mouse, pen, touch-screen, or similar input device. Alternately, mouse actions 614 may pertain only to actions taken with a mouse, and the other input devices may be handled using other categories 604, or may be ignored. Unless otherwise indicated, mouse actions pertain to actions taken with a mouse and/or with any other cursor-positioning/pointing device (pen, touch-screen, track ball, touch pad, etc.). In some embodiments, possible mouse actions include one or more of the following: Mouse over (when the mouse initially enters an element's screen territory, e.g., when a mouse-driven cursor 404 initially enters a screen region 406); Mouse out (when the mouse leaves an element's territory); Mouse move (when the mouse moves within an element's territory); Mouse down (a mouse button is pressed over an element's territory); Mouse up (a mouse button is released over an element's territory); Mouse click (when a mouse down+mouse up combination occurs over the same location); Mouse double-click. Some embodiments implement only some of the foregoing Mouse actions, and some implement other mouse/pointing device actions.

Keyboard actions 616 pertain to user actions made with a mechanical or virtual (on-screen) keyboard. In some embodiments, possible keyboard actions include one or more of the following: key down, key up, key press (rapid down—up combination).

In some embodiments, an association 620 exists between a record 214 (e.g., an element specifier 602 and an action category 604) and pixel data such as a screenshot 622 and/or video clip 624 of a browser display. For example, filenames, Universal Resource Identifiers (URIs), and/or other pixel data identifier(s) may be stored in a record 214. In some embodiments, marker frame(s) 626 are inserted in video clip(s) 624 referring to specific record(s) 214, e.g., by embedding URIs, filenames and offsets, or other record 214 identifiers in a video clip frame sequence metadata. Marker frames can be used to synchronize records 214 with video frames, so that particular frame(s) are displayed in a player browser in conjunction with interpretation of particular interaction records 214.

In some embodiments, a cross-browser structure includes one or more normalized records 214, each having an element ID attribute value 308 of the pertinent element 208 and an action category 604 value which corresponds with at least one of the following mouse actions 614: mouse-click, mouse-over, keyboard. In some embodiments, a cross-browser structure includes one or more normalized records 214, each having an object name 608 of the pertinent element 208 (a.k.a., Object ID, object type name, e.g., <div> element, <p> element, etc.), a DOM tree position 310 of the pertinent element 208, and an action category 604 value which corresponds with at least one of the following: mouse-click, mouse-over, keyboard action 616. Of course, other variations based on the description herein are also possible.

Methods

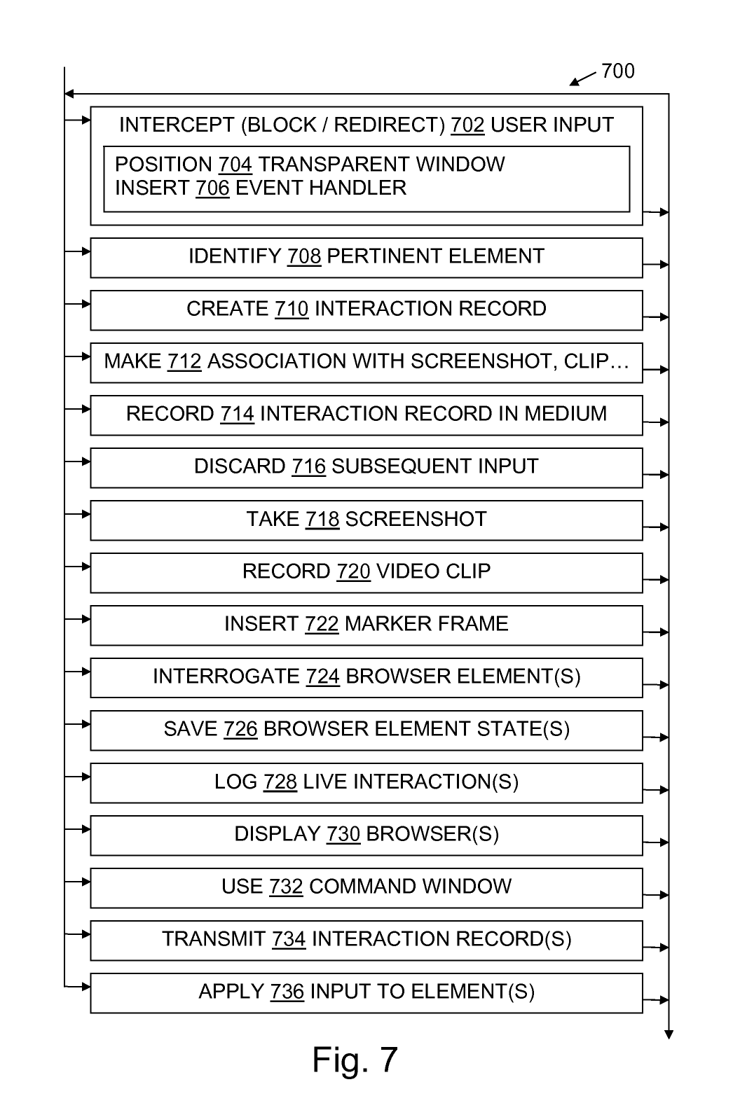

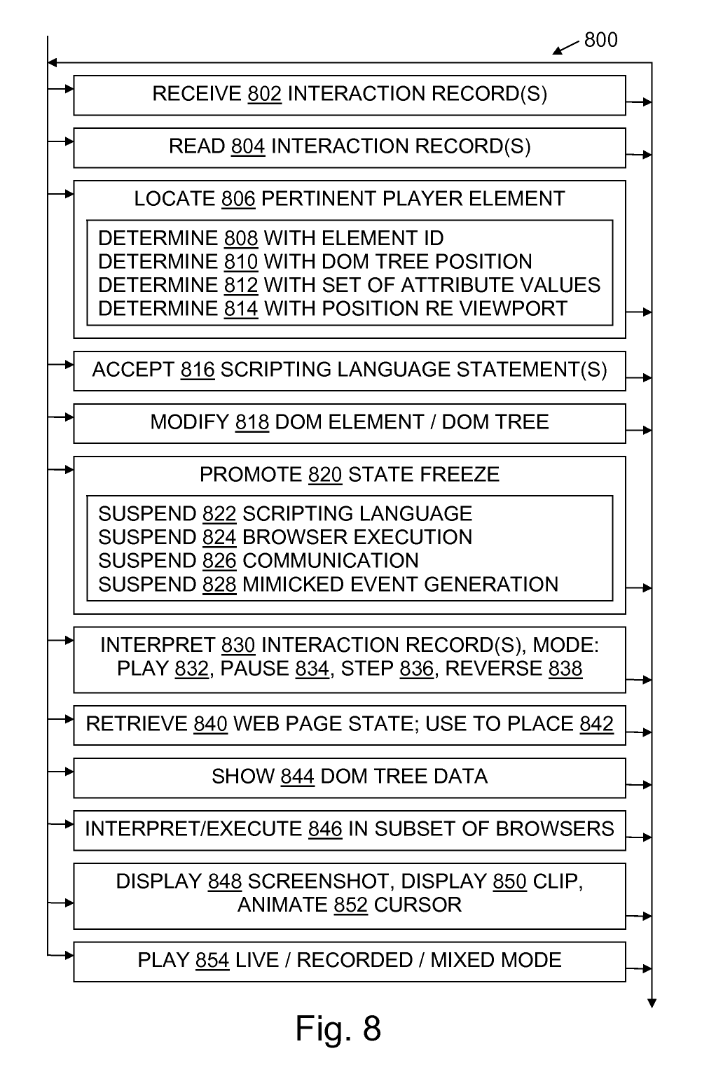

FIGS. 7 and 8 illustrate some method embodiments in flowcharts 700 and 800. Methods shown in the Figures may be performed in some embodiments automatically, e.g., by a player browser 206 and interactivity testing code 204 playing back a sequence of normalized records 214 requiring little or no contemporaneous (live) user input. Methods may also be performed in part automatically and in part manually unless otherwise indicated. Particular steps may be done automatically, regardless of which steps are specifically described as automatic. In a given embodiment zero or more illustrated steps of a method may be repeated, perhaps with different parameters or data to operate on. The flowcharts are not mutually exclusive; a given method may include steps shown in FIG. 7, steps shown in FIG. 8, or steps from each Figure, for example. Steps not shown in either flowchart may also be included. Steps in an embodiment may be done in a different order than the top-to-bottom order that is laid out in the flowcharts, as indicated by this statement and by the flowchart looping facilities. Steps may be performed serially, in a partially overlapping manner, or fully in parallel. The order in which a flowchart is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During an intercepting step 702, an embodiment blocks, redirects, or otherwise intercepts a user input 120. Step 702 may be accomplished by positioning 704 a transparent window 302 in front of a browser, by inserting 706 an event handler(s) 304, and/or by other mechanism, for example.

During an identifying step 708, an embodiment identifies a pertinent element 208/210, namely, the element to which a user input is directed. Step 708 may be accomplished in various ways. For example, a mouse action screen position may be matched with element screen regions to identity a target element. As another example, an event handler may be inserted 706 to intercept events, in effect letting an original event handler determine which element is targeted, and then tapping into that determination to identify the pertinent element. As another example, a DOM tree 132 may be made into an enhanced DOM tree 314 by inserting method(s) 316 onto elements, the inserted method(s) being configured to raise an event, send a message, or otherwise notify interactivity testing code 204 when the element in question receives input.

During a record creating step 710, an embodiment creates an interaction record 214, e.g., by writing in a medium 112 values for some of the items shown in FIG. 6. In some embodiments, creating 710 a record 214 includes making 712 an association between pixel data and other items such as an element specifier 602 and/or an action category 604. In some embodiments, creating 710 a record 214 includes recording 714 the interaction record values in a medium 112, such as a nonvolatile medium.

During an input discarding step 716, some embodiments discard input, e.g., they discard input to a browser after particular input is received. For example, inputs that merely move a cursor slightly, without changing the DOM element that has the user input focus, may be discarded after an input which sets that element 130 as the focus element. Some embodiments discard input for mouse movements within an element's bounds. This may happen frequently, as web pages rarely have event handlers that would change the page in these cases. According, as an optimization an embodiment may discard such movements; a mode may also be provided to disable the discarding behavior. In some configurations which element has user input focus is unimportant, e.g., if one clicks in a search text box, it has input focus but one can still mouse around the rest of the page. A more pertinent thing in such configurations is not that the element with input focus does not change, but rather that no elements change.

During a screenshot taking step 718, some embodiments store pixel data in a medium, including a file or other data structure holding a snapshot of part or all of a display as configured by a recorder browser. Metadata such as time, browser ID, and user name may be associated with the screenshot.

During a video clip recording step 720, some embodiments store a sequence of pixel data frames in a medium, including a file or other data structure holding a video clip of part or all of a display configured by a recorder browser. Metadata such as the metadata for a screenshot may be associated with the video clip. In some embodiments, one or more marker frames 626 is inserted 722 in the video clip, identifying particular interaction record(s) 214 with a particular point in the sequence of video clip frames. In some embodiments, recording either video (screen capture) or selected screen shots facilitates work with a system in which one of the player browsers is cloud-based. A developer can view the cloud-based browser's interactivity side-by-side with local browsers. One technique is to juxtapose the local interactivity with a video or screen shot representation of the cloud interactivity.

During an interrogating step 724, an embodiment interrogates an element 130 regarding its position, styling, attribute presence(s), attribute value(s), and/or other characteristics. Familiar mechanisms for interrogating element(s) can be used. Some embodiments allow (and some require) a developer to freeze a browser before interrogating element(s) in that browser. After interrogation, suspended operations can be resumed to continue interactivity testing with additional input to the browser. In some embodiments, interrogation is followed by a state saving step 726, in which browser element state(s) obtained by interrogation are saved in a medium 112, allowing their subsequent retrieval from a structure 220, for example.

During a logging step 728, live interactions between a user and a browser are logged in a cross-browser structure 220, e.g., as a sequence of interaction records 214.

During a displaying step 730, an embodiment displays one or more browsers. In some embodiments, a recorder browser 202 and a player browser 206 are displayed together on a single screen, as illustrated in FIG. 4. In some embodiments, a recorder browser is displayed on one device and at least one player browser is displayed on a different device. FIG. 5, for instance, shows a configuration in which browsers are displayed on four devices. Step 730 may be done using familiar user interface mechanisms.

During a command entering step 732, a user uses a command window 222 to enter one or more commands 224 into a user interface of interactivity testing code 204.

During a transmitting step 734, normalized records 214 are transmitted over a network or other communication link to player browser(s). In some embodiments, the transmitting step 734 is performed when playing back activity into remote player browser(s).

During an applying step 736, user input is applied to element(s). For instance, a user input 120 may be applied to an element in a recorder browser by allowing the browser to create a system level event as it typically would in the absence of interactivity testing code 204 except that a normalized record 214 of the input is made for use by player browser(s). The same user input 120 may then be applied to an element in a player browser by generating a system level event based on the normalized record 214. Applying step 742 does not necessarily require that one apply the user input to the leader browser; one could simply intercept the input event and let it funnel through. That is, one does not necessarily actively apply the user input but may instead passively apply the input.

During a record receiving step 802, an embodiment receives interaction record(s) 214 from a network connection, shared medium 112, or other transmission mechanism. For instance, an embodiment may receive 802 records 214 that were transmitted 734 from a remote network node, may receive 802 records that were recorded 714 on a hard drive, or may receive 802 records that were placed in a memory stream by a recorder browser that is still running.

During a reading step 804 an embodiment reads one or more interaction record(s) and parses them to find values such as an element specifier 602 and an action category 604.

During a locating step 806, an embodiment locates a pertinent element, such as a pertinent player element 210 corresponding to a pertinent recorder element 208. Step 806 may be accomplished using various determinations 808-814. For example, during element ID determining step 808, usable if the pertinent recorder element has an ID attribute value 308 which distinguishes it from other elements of the page 128 in question, step 806 can be done by finding (e.g., by indexed access, or tree traversal) the element in the player browser that has the same ID attribute value. Otherwise, during tree position determining step 810, the pertinent recorder element's position 310 in the DOM tree can be used, e.g., in the form of an ordinal element encountered during a specified traversal of the DOM tree, or as the destination element reached by a specified path taken from the root which indicates which tree link to follow at each intervening element. During a determining step 812, an identifying set 312 of attribute values is used to test each possible element in the player DOM tree until the pertinent player element (the element with the same set 312 of values) is located. During a view position determining step 814, an element approximation 610 based on position relative to a viewport can also be used in some embodiments, e.g., by making an assessment based on mouse coordinates and screen regions, or by tiling the page into screen regions by DOM element.

During a statement accepting step 816, an embodiment accepts and operates on statement(s) 226, such as scripting language 216 statements 226 or C# statements 226, for example. Statements 226 may be accepted through a command window 222, or within a sequence of interaction records 214, for example. Some embodiments work with a record of elements and with actions that are applied to those elements. The embodiment finds each element and applies the action to that element. Both the element identification and an instruction to apply the action may be part of the script. For instance, a script statement might be “apply click event to element with id=”o99”.”

During a DOM modifying step 818, an embodiment modifies an element 130 in a DOM tree and/or modifies DOM tree characteristics such as the number and location of element(s). Familiar mechanisms for modifying DOM elements and DOM trees can be used.

During a freeze-promoting step 820, a.k.a. freezing step 820, an embodiment freezes or assists in freezing the state of DOM element(s) 130 in a browser 202/206. For instance, step 820 may include suspending 822 execution of JavaScript® code, Cascading Style Sheet code, or another scripting language 216. Step 820 may include suspending 824 browser 202/206 execution, using breakpoints or HALT instructions, for instance. Step 820 may include suspending 826 communication between a browser 202/206 or browser 202/206 device and a web server 142, e.g., by halting AJAX (asynchronous JavaScript® and XML) and other processes that communicate using XML, HTML, HTTP, TCP/IP, and/or other familiar formats and protocols. Step 820 may include suspending 828 generation of system level events to mimic direct user input to a player browser. Some embodiments support automatic freezes when one or more specified interactivity conditions are met, e.g., “freeze when I mouse over the element with ID=menu” or “freeze when the CSS background color of the element with ID=menu becomes RED”. In particular, some embodiments support “change” or “data” breakpoints that are set when the DOM changes in some specified way.

During a record interpreting step 830, an embodiment interprets interaction record(s) 214 in player browser(s) 206. From an embodiment's perspective, step 830 includes reading the user-browser interaction record 214, locating 806 a pertinent element in a player browser, and applying 736 the user input to the pertinent element. In some embodiments, step 830 also includes displaying 730 the player browser after applying the user input. From a user's perspective, step 830 may be part of, or provide context for, steps such as playing 832 a sequence of interactions, pausing 834 play, stepping 836 through interactions one (record 214) at a time, and/or reversing 838 playback to show interactions in the opposite order from their original recording sequence.

During a state retrieving step 840, an embodiment retrieves from a medium 112 web page state information, such as DOM element values, which were previously saved 726 during recording of user-browser interactions.

During a placing step 842, an embodiment uses retrieved 840 state information to place a browser in a particular state. The state will often be a state the browser could have been taken into by repeating s sequence of user-browser interactions, but some states may also include values caused by direct modification 818 of a DOM element or a DOM tree. In some embodiments, the browser can be put in that state by executing the sequence of steps, or by simply putting all of the DOM elements and Javascript execution at the point indicated by the recorder browser.

During a showing step 844, an embodiment shows DOM element and/or other DOM tree data on a display 122. Familiar user interface tools can be used to show 844 data.

During a subset interpretation step 846, specified statement(s) 226 and/or specified interaction record(s) 214 are used in a proper subset of previously selected player browsers. For example, values in each of several player browsers may be individually modified 818 to test several cases simultaneously during playback.

During a screenshot displaying step 848, previously taken 718 and stored screenshot pixel data is displayed in or near a player browser's window.

During a video clip displaying step 850, previously recorded 720 video pixel data is displayed in or near a player browser's window. Steps 848 and 850 may be synchronized with interpretation 830 of interaction record(s) 214, by use of associations 620 and/or marker frame(s) 626, for example.

During a cursor animating step 852, an embodiment simulates in a player browser window some user-controlled cursor movement. For example, if a record 214 refers to an element A and the next record 214 in a structure 220 refers to an element B, then the embodiment may generate artificial cursor movement from the center of a screen region 406 of element A to the center of a screen region 406 of element B. In some embodiments, an event handler “simulates” events by capturing and responding to them.

During a playing step 854, an embodiment plays a player browser using interpretation 830 of interaction record(s) 214, execution of live user input 120, and/or execution of commands 224 and/or statements 226. That is, step 854 may include a mixed mode operation of player browser(s) in which recorded and live input is presented to the browser in a mixture.

During step 854, some embodiments invoke an inserted method 316 defined in an enhanced DOM tree 314, to update interactivity testing code 204 about the circumstances or content of an element 130 to which the invoked method is attached. Familiar method invocation mechanisms can be used. Note that some embodiments capture an event and the element associated with the event. In order to play the event back to the same element in the player browser, some embodiments simulate a system event at the location of the element in the player browser. An enhanced DOM is not necessarily used in every embodiment. Some embodiments simulate an event through the browser (instead of the system), so an enhanced DOM tree is not required; instead the embodiment traverses the tree and plays the event to the pertinent object.

During step 854, some embodiments snap a cursor 404 (e.g., a virtual cursor) to screen position(s) corresponding to targeted element(s). Consider software that merely records mouse movements and keyboard input, without relating those user inputs to DOM elements as described herein. If the recorded inputs were replayed into a different browser whose elements have somewhat different screen regions because of differences in layout engines, for instance, then different elements could well receive the input during playback than during the recording. With embodiments described herein, by contrast, the same elements can receive the input events. During playback, a visual indication that inputs are being handled on a per-element basis may be that the cursor snaps (jumps/moves discontinuously) from element region to element region rather than moving continuously as it would in a video recording. In some embodiments, the snapping step is an optional step when playing back activity into player browser(s). Cursors may also be animated 852 in some configurations.

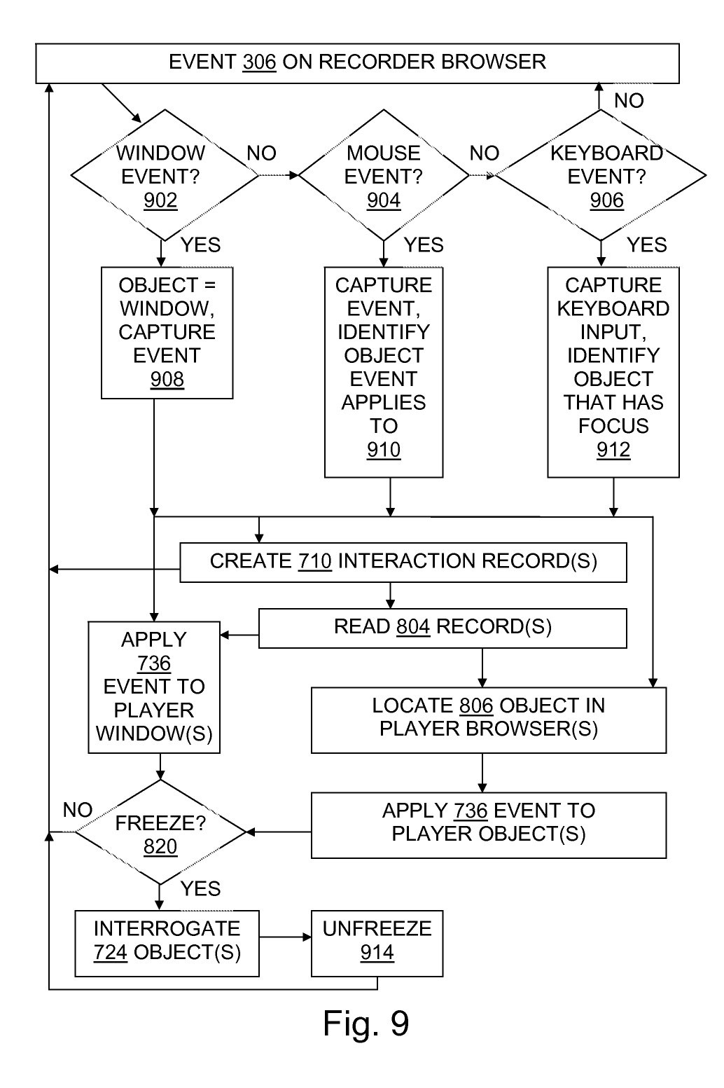

FIG. 9 shows another view of some embodiments. A developer selects a recorder browser 202 and selects one or more player browsers 206. Interactivity testing code disables events on the player browsers, e.g., by blocking or otherwise intercepting 702 direct user input after installing mechanisms 212. An event 306 occurs on the recorder browser, and the interactivity testing code 204 determines whether the event is a window event 902, a mouse event 904, or a keyboard event 906.

A window event is captured 908 and the window object is noted, e.g., in a normalized record 214 created 710 by the code. In a record-only configuration, control loops back to await the next recorder browser event 306. In a record-and-play configuration, the record 214 is read 804 and the window event is applied 736 to the player browser(s) respective window(s).

A mouse event is likewise captured 910 and the object (element) that the mouse event targets is identified 708. In a record-only configuration, control loops back to await the next recorder browser event 306. In a record-and-play configuration, the record 214 is read 804 and the mouse event is applied 736 to the pertinent object(s) after they are located 806 in the player browser(s).

A keyboard event is likewise captured 912 and the object (element) that the keyboard event targets is identified 708. In a record-only configuration, control loops back to await the next recorder browser event 306. In a record-and- play configuration, the record 214 is read 804 and the keyboard event is applied 736 to the pertinent object(s) after they are located 806 in the player browser(s).

In some embodiments, a developer may freeze 820 the state of the recorder browser and/or the player browser(s). Selected object(s) can be interrogated 724, before unfreezing 914 the browser(s) and continuing interaction with the objects. Interaction may include direct input to the recorder browser and/or simulated matching interaction in the player browser(s).

During applying step(s) 736, some embodiments generate a system level event, encapsulating actions such as a window action 612, a mouse action 614, or a keyboard action 616. Unlike familiar system level events, generated system level events occur in response to a normalized record 214 or other communication from recorder browser interactivity testing code, not from user input directed at an isolated browser. However, the same event data formats can be used in generated system level events as in familiar system level events.

Some embodiments can be characterized, at least for convenience, by primary functionality with regard to two basic scenarios for playback. In one scenario, an embodiment is working against an actual browser instance and interacting with it. In a second, an embodiment is emulating the playback experience using other data; no browser code is getting executed. For this latter scenario, it may appear that users are simply watching a video in which a browser is executing although the browser is not currently executing. In another example, an embodiment displays a captured screenshot and may also animate a fake mouse cursor to simulate the user interaction.

In the first scenario, with a live browser, it may be difficult to easily move backwards in time for playback. To do so, details such as the current DOM/mark-up source would have to have been recorded in persistent medium (e.g., in memory or on disk) during live playback. Storage and data transfer limitations may make such recording undesirable or unrealistic in a given configuration.

In the second scenario, the notion of ‘interpreting each user-browser action’ is not necessarily relevant. Instead, one has a notion of a place in the playback sequence, and data that allows an embodiment to snap to the appropriate display/playback state, possibly with some cursor animation.

A given embodiment may be focused on the first (live browser) scenario, or the second scenario, or may support each of these scenarios. Some embodiments support snapping to a live browser playback based on persisted DOM/other state. Some support interpreting each user-browser interaction in a recorded sequence of user-browser interactions, in one of the following ways: by reading the captured data associated with the interaction, performing any animations of the cursor, and displaying a graphic that shows the rendered page at the time of recording; by playing back a sequence from a recorded video that shows the user-browser interaction as it occurred when recorded. Moving forward in playback involves executing a live user input gesture or interpreting a recorded interactivity gesture. Some embodiments deal with pause, step, and reverse modes only, and do not support restoring browser state. Some assume a recorded sequence, not a live page. Pause can be done by a breakpoint or by a pause button, for example. Other embodiments support restoring state.

Some embodiments support setting a breakpoint in the sequence structure 220 to specify a pause that is not initiated by a user gesture but rather by specifying the pause point in the playback script. Some support a playback ‘continue’ or proceed gesture, e.g., through the command window 222. Other commands 224 may persist scripts (e.g., structures 220) to a store (medium 112) and reload them to be interpreted. Some embodiments support bringing a browser to a specified state using a breakpoint in a script structure 220. A script can be paused, and a live command window 222 can be used in a paused state, e.g., to bring the browser into a specified state and to edit the live DOM tree. In addition to editing the live DOM tree, a user might perform any other command 224, and could start a JavaScript® debugging experience in another tool, and/or could interact with the page to alter it without recording those interactions.

The foregoing steps and their interrelationships are discussed in additional detail below, in connection with various embodiments.

In some embodiments, a browser interactivity recording process is provided, utilizing at least one system 102 or device which has at least one display 122, at least one logical processor 110, and at least one memory medium 112 in operable communication with a logical processor and a display.

Some processes include automatically intercepting 702 a user input to a browser. In some embodiments, the intercepting step includes positioning 704 a transparent window in front of a browser window to receive a user input device signal directed at the browser. In some embodiments, the intercepting step includes inserting 706 an event handler 304 configured to intercept events caused by user input device signals, the event handler not present in an original version of the web page on a web server. Some embodiments rewrite the page 128 to achieve interception 702; in other embodiments, rewriting the page is optional. Event handlers 304 can be added in some embodiments via DOM hooks without rewriting the page.

Some processes include identifying 708 a pertinent element, namely, a Document Object Model element in the browser which is configured to respond to the intercepted 702 user input.

Some processes include creating 710 a cross-browser structure 220 (or an individual user-browser interaction record 214) which specifies the identified pertinent element and the user input.

Some processes include recording 714 the cross-browser structure in a computer-readable storage medium, and in particular, recording record(s) 214 in a nonvolatile such as a hard disk.

In some embodiments, the device has a cursor-positioning device. After identifying the pertinent element and intercepting a user input directed to the element, some processes discard 716 subsequent cursor-positioning device user input until the cursor is moved outside a screen territory (region 406) that is assigned to the pertinent element 130.

In some embodiments, system-level events are generated in a player browser. Some embodiments invoke a method 316 defined in an enhanced DOM tree 314. Other embodiments do not necessarily have an enhanced DOM tree, but instead directly invoke an onClick handler 304 on a non-modified DOM tree. Some embodiments execute in a browser plug-in/add-in model.

In some embodiments, the creating step 710 creates a cross-browser structure 220 (or individual record 214) having an element ID of the pertinent element, and an action category.

Some embodiments make an association 620 in the computer-readable storage medium which associates the cross-browser structure 220 (or individual record 214) with at least one of the following: a screenshot 622 of the browser; a video clip 624 of the browser as multiple user inputs are applied to multiple browser Document Object Model elements; a data 606 representation of at least a portion of a source code of the web page; a data 606 representation of at least a portion of a Document Object Model tree of the web page.

Some embodiments provide a computer-readable storage medium configured with data and with instructions that when executed by at least one processor 110 causes the at least one processor to perform a process for cross-browser interactivity testing.

In some embodiments, the process includes automatically reading 804 a user-browser interaction record 214 from a cross-browser structure 220. The user-browser interaction record specifies a Document Object Model element and a user input. The process locates 806 a pertinent element in a player browser, namely, a Document Object Model element in the player browser which corresponds to the element specified in the user-browser interaction record. The process applies 736 the user input to the pertinent element, and displays 730 the player browser after applying the user input.

In some embodiments, the locating 806 and applying 736 steps are performed for at least two player browsers 206, and the player browsers are displayed 730 simultaneously after the applying steps. One may use a single user-browser interaction record 214 to control behavior of corresponding document elements in different browsers. In some configurations, playback occurs in browsers that are all be the same kind of browser, e.g., in a classroom or seminar setting. In some embodiments, the locating 806 and applying 736 steps are performed for at least two player browsers of at least two different kinds, thereby using a single user-browser interaction record 214 to control behavior of corresponding document elements in different kinds of browsers. In some embodiments, the locating 806 and applying 736 steps are performed for at least two player browsers on at least two machines, thereby using a single user-browser interaction record 214 to control behavior of corresponding document elements in browsers on multiple machines. Some embodiment use a cross-machine scenario, e.g., synchronized playback across multiple machines in a classroom setting. Some use different kinds of browsers, e.g., Microsoft Internet Explorer® browsers and Apple Safari® browsers, as one example, or Microsoft Internet Explorer® version 6 and version 7 browsers, as another example.

In some embodiments, the user-browser interaction record reading step 804 is preceded by automatically intercepting 702 a user input to a recorder browser which is a different kind of browser than the player browser; by identifying 708 a target Document Object Model element in the recorder browser which is configured to respond to the intercepted user input; and by creating 710 the user-browser interaction record from the target element and the intercepted user input. One may record in one kind of browser and playback in a different kind of browser.

In some embodiments, the step of locating 806 a pertinent element in a player browser includes one or more of the following: automatically determining 808 that the player browser element has an identifying element ID attribute value that also identifies the user-browser interaction record element; automatically determining 810 that the player browser element has an identifying DOM tree position that also identifies the user-browser interaction record element; automatically determining 812 that the player browser element has a set of element style properties and/or attribute values that also identifies the user-browser interaction record element; and/or automatically determining 814 that the player browser element has a combination of element attribute values and a position with respect to viewport origin that also identifies the user-browser interaction record element.

In some embodiments, the process includes interrogating 724 a player browser Document Object Model element. In some, the process includes accepting 816 a scripting language statement and in response to the accepted statement modifying 818 a player browser Document Object Model element. In some embodiments, the process includes storing (saving 726) the current state of player browser Document Object Model elements in a non-volatile computer-readable medium 112. In some configurations, a scripting language statement modifies 818 the DOM element so that it can indicate what event is being triggered. Both the DOM element and the event are stored for later playback. Script may be used in some configurations to modify 818 an element, with or without also interrogating 724 the element, and with or without also saving 726 the element changes to disk.

In some embodiments, which may focus on playback in a live browser, the process includes interpreting 830 in a live browser each user-browser interaction in a recorded sequence of user-browser interactions, by reading a user-browser interaction record 214, locating 806 a pertinent element in a player browser, applying 736 the user input to the pertinent element, and displaying 730 the player browser after applying the user input. In some cases, playback is paused 834, namely, the step of interpreting the sequence of user-browser interaction records is paused until a command 224 is received to continue playback. In some cases, playback occurs in a step 836 mode, namely, the step of interpreting each of a sequence of consecutive user-browser interaction records is triggered by a respective user command 224.

In some embodiments, the process includes displaying 848 a screenshot 622 recorded from a browser, illustrating an application 736 in that browser of at least one user-browser interaction. In some, the process includes displaying 850 a video clip 624 recorded from a browser illustrating an application 736 in that browser of multiple user-browser interactions. In some embodiments, the process includes animating 852 a cursor during display 730 of at least one image (screenshot, video clip) recorded from a browser, illustrating an application 736 in that browser of multiple user-browser interactions. In some, the process includes showing 844 DOM tree data which is synchronized (by association 620, marker frame 626, or otherwise) with at least one image recorded from a browser illustrating an application 736 in that browser of at least one user-browser interaction.

In some embodiments, the process includes displaying 730 in a single screen a browser window for each of at least two browsers 202, 206, thereby using limited screen space efficiently by focusing attention on currently active portions of the browsers. This may be done, for example, by displaying two browser windows as application sub-windows. These windows can be tiled or overlapping.

In some embodiments, the process includes receiving 802 at the player browser multiple user-browser interaction records 214 transmitted 734 across a network 108, using the received browser interaction records to locate 806 pertinent element(s) in the player browser, using the received user-browser interaction records to apply 736 user inputs to the pertinent element(s), and displaying 730 the player browser after applying at least one of the user inputs.

In some embodiments, the process includes placing 842 a player browser in a specified state by loading a previously stored DOM tree state. This state loading can be an alternative to interpreting a sequence of user-browser interactions to reach the specified state. In some situations, more than the DOM tree state is used, e.g., if JavaScript® code was executed, then the embodiment would also reproduce the execution state of the script, such as current statement and variable values.

In some embodiments, the process includes interpreting 830 each browser interaction record in a sequence of browser interaction records, in reverse order from an order in which the browser interactions were performed. That is, playback is performed in a reverse 838 mode. Playback in some embodiments allows but does not require a live browser.

In some embodiments, the step of locating 806 a pertinent element includes at least one of the following: determining 808 that the element has an identifying element ID attribute value that also identifies the pertinent element in another browser; determining 810 that the element has an identifying DOM tree position that also identifies the pertinent element in another browser; determining 812 that the element has a set of element style properties and/or attribute values that also identifies the pertinent element in another browser; determining 812, 814 that the player element has a combination of element attribute values and a position with respect to viewport origin that also identifies the pertinent element in another browser. In some embodiments, a dynamically determined set of element style properties and/or attribute values is used; these values of elements in the DOM tree are examined and a set of values which belongs only to the pertinent element is found and used. In some embodiments, a predetermined set of element style properties and/or attribute values is used, based on the assumption that this set will always distinguish any element 130 from the other elements of the page. In some situations, however, a set of element attribute values will match multiple elements, one of which will then be chosen, e.g., by default or by user selection. In some embodiments, the same document is loaded in multiple browsers, and the browsers are sized to the same pixel dimensions.

In some embodiments, the step of applying 736 the user input to the pertinent player element includes generating a system level event in the player browser despite the absence of direct user input to the player browser. Such generated events mimic (simulate) direct user input, by replicating at the element 130 level the user input that was given directly to the recorder browser.

In some embodiments, the step of applying 736 the user input to the pertinent player element includes invoking on the pertinent player element a method 316 defined in an enhanced DOM tree. Such methods 316 may also be referred to as methods defined by the DOM. Methods 316 include, but are not necessarily limited, scripting language methods (e.g., in Sun Microsystems JavaScript® code, Adobe ActionScript® code, Microsoft VBScript™ code), and methods in other programming languages such as C# or C++, for example. The DOM defines methods that the elements 130 of the DOM expose, and these methods can be called from scripting languages 216 and statements 226 in other languages.

In some embodiments, the process includes promoting 820 a state freeze by performing at least one of the following: suspending 822 a scripting language in the recorder browser (e.g., turn off JavaScript® machine); suspending 822 a scripting language in the player browser; suspending 824 execution of a browser; suspending 826 communication between the recorder browser and a web server (e.g., turn off AJAX); suspending 826 communication between the player browser and a web server; suspending 828 generation of mimicked system level events in the player browser, namely, events which simulate but are not caused by direct user input to the player browser.

In some embodiments, the process includes interrogating 724 a browser about a browser element's position and/or styling by reading attribute values. In some embodiments, interrogation 724 happens during a frozen state. Otherwise, the DOM could be changing while the interrogation is happening, which could make readings unreliable. Information obtained by interrogation 724 can be displayed to the user and/or recorded it for possible later examination. In some embodiments, interrogation occurs automatically without requiring a frozen state, e.g., a breakpoint could be based on interrogation: “stop when element X style becomes S1”.

In some embodiments, the process further includes rewriting HTML of a document that is displayed in the player browser, the rewriting (a form of intercepting 702) corresponding to user interaction with the recorder browser.

In some embodiments, the process further includes simulating user input events in the player browser by generating events, e.g., sending a click to element X. Some embodiments use page rewritten to insert JavaScript® code to hook up event handlers 304 as simulators. Some embodiments avoid rewriting but instead use methods/events exposed via the DOM.

In some embodiments, the process includes snapping a display cursor back to a pre-interrogation screen position after the interrogating step. The actual cursor driven directly by a mouse is in the recorder browser; some embodiments simulate a cursor in the player browsers. Depending on the implementation, the player cursor(s) do not necessarily track every movement of the recorder cursor. For instance, interactivity testing code may ignore movements within an element's region 406 and simply have the cursor jump from element region to element region. In fact, since the same element 130 may layout differently in different browsers, the player cursors may well jump between element regions during interactivity testing. In some embodiments, the recorder browser's cursor always tracks the mouse. A player browser's cursor may only move from element to element, or at least not completely track all mouse movements within an element.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as interactivity testing code 204, mechanism(s) 212, and/or normalized records 214, in the form of data 118 and instructions 116, read from a removable medium 114 and/or another source such as a network connection, to form a configured medium. The configured medium 112 is capable of causing a computer system to perform method steps for transforming data through interactivity testing as disclosed herein. FIGS. 1 through 9 thus help illustrate configured storage media embodiments and method embodiments, as well as system and method embodiments. In particular, any of the method steps illustrated in FIGS. 7-9, or otherwise taught herein, may be used to help configure a storage medium to form a configured medium embodiment.

### ADDITIONAL EXAMPLES

Additional details and design considerations are provided below. As with the other examples herein, the features described may be used individually and/or in combination, or not at all, in a given embodiment.

On an HTML page 128, all the individual page elements 130 are organized in a tree hierarchy known as the document object model (DOM). Every DOM element 130 can listen-to and react-to user-initiated actions via an event mechanism. The DOM hierarchy can vary from browser to browser, and even from browser version to browser version. Using teachings herein, for a given page the browser DOMs can be normalized so the hierarchies can be treated identically. In some embodiments, browser DOMs are normalized in the sense that the embodiment matches corresponding elements across divergent DOM trees. A set of recorded actions is normalized, allowing one to play back to the matched elements across browsers. Embodiments provide mechanisms for re-applying normalized tree element messages (e.g., records 214) across a range of browsers. Embodiments allow developers to view interaction created in one browser as it is replicated contemporaneously or after a desired time (hours, days, weeks, months, or even years) at the DOM element level across a range of other supported browsers. Unlike solutions to cross-browser diagnostics and debugging that focus solely on page layout, embodiments described herein allow interactivity testing and create permanent records of interaction for later use, evaluations, and modification.

In some embodiments, a user can work with a page display in a recorder browser and in an arbitrary number of player browsers. Results of user initiated actions taken in the recorder browser (e.g., clicks, mouse-overs, drag events) are displayed in near-real-time in the player browsers. Some embodiments operate by intercepting 702 events on DOM objects, recording user input and targeted element identity, and then replaying those events on the identical page elements in the other browsers. This allows the user to evaluate whether the page's interactive behavior operates identically from browser to browser, and to edit or annotate a recording of the interactions. Because of browser rendering differences, DOM elements will sometimes not be located in the same physical (x, y) screen position across recorder and player browsers. Thus, embodiments do not simply simulate a system event at a given location within a window, but instead locate 806 the affected element in player browser DOMs and apply the operation to that element.

Some embodiments provide a mechanism for generating and recording page interactions described both as operations against mark-up elements as well as application-level messages (e.g., explicit mouse coordinates). Some embodiments provide a mechanism for raising/lowering system messages (such as a mouse movement at a specific screen coordinate) to and from an element in the DOM tree (such as a hover over an <Ii> tag).

In some embodiments, player browsers can be located on the same physical machine as the master, or on different machines communicating across a local network or the Internet. Some embodiments include an interactivity testing code 204 interface that hosts multiple browsers on the same machine and allows them to be easily compared and viewed together.

In some embodiments, interactivity can be frozen at any point for comparing layouts across browsers. An interface for seeing what operations are being applied and have been applied to which elements can be utilized, based on familiar or innovative mechanisms. Some tools provide cross-browser debugging and diagnostics for identifying page layout problems across multiple browsers. Embodiments described herein address additional aspects.

One aspect concerns how one can test the layout of web pages that require some interactivity to get into a particular state. For example, a web page 128 that is behind a log-in screen needs to have that log-in information filled in and submitted before the page layout of interest can be analyzed. To compare the page in multiple browsers, each browser (recorder and player(s)) receives the same log-in information and submits it to a server at (potentially) the same time. As another example, in the case of comparing content that is hidden behind a so-called “accordion control” the accordion control should be triggered before the content layout is compared. Embodiments described herein allow the accordion control to be triggered so the layouts in all the browsers of interest can be compared.

Another aspect concerns how one can test interactivity across multiple browsers. Increasingly, web pages 128 are incorporating interactive elements such as menus, tree controls, overlay controls, photo galleries, etc. Because the HTML/CSS and JavaScript® machine implementations vary across different browsers, developers can benefit from testing this interactivity simultaneously across multiple browsers to ensure that it works correctly.

Some familiar approaches help a web page author debug cross-browser layout issues by taking a picture of a web page as rendered in multiple browsers and then providing a set of tools to help compare these pictures and the elements used to create them. By contrast, some embodiments described herein link multiple live browsers, thereby allowing interactivity to be comprehensively compared across these browsers.

In some embodiments, the browsers are hosted in a common interface which allows a user to easily select the browsers to be compared. In the case of the two browsers shown in FIG. 4, the browser on the left is the “baseline” or recorder browser and the right browser is the player. Some embodiments allow multiple player browsers.

Suppose a web page has a set of pop-up menus that become visible when the user moves the cursor over a word in the navigation strip. An HTML document is composed of a series of elements 130 that populate a tree-style hierarchy known as the Document Object Model (DOM). Each type of element has a variety of events it can respond to, such as mouse-over, click, double-click, focus, etc. The events can also propagate upwards from child elements to their parents. Some embodiments block player browsers from receiving any system level messages regarding direct window input, so the player(s) won't react to any direct clicks or mouse movements in their respective window(s). Within the recorder browser window, mouse and keyboard events are intercepted. For mouse events, the position of the cursor is tracked, and the element 130 beneath the cursor is associated with each mouse event, e.g., in a normalized record 214. In the case of keyboard events, the element with focus is associated with each key input. In one example, a mouse over event occurs when the user moves their cursor over the words “About Me” in the navigation strip.

Once the event and associated element have been read 804 or otherwise identified, they will be applied to the player browser(s). Messages associated with the recorder window (and not with page elements), such as move and resize, are applied to the player browser's window in the form of system messages. Events that are applied to page elements in the recorder browser are applied to the corresponding page element in the player browsers. The display (screen and/or viewport) location of the corresponding element in the player browsers may not match the location of the element in the recorder browser, so the location of the element involved is found. Since the DOM trees may not be identical between recorder and player browsers, the target page element is algorithmically identified in the recorder browser and located in the player browsers. Once the element is found, the event is programmatically applied to the element. When an event is replayed to the corresponding element in the player browsers, they will demonstrate the same behavior as the recorder, if the page is compatible across different browsers, or different behavior if the page is not compatible.

In some cases a user may want to test/examine the layout of elements at a particular interactive state, such as when a menu is extended. In this case, some embodiments can freeze the interactivity. In one example, hitting the F11 key will freeze the state of the recorder and player browsers. At this point the user can interrogate 724 the browsers for the position and styling information for each element to determine what the source of any discrepancy might be. Hitting F11 again will unfreeze the interactivity, allowing the user to trigger events in the browsers once more.

Embodiments are not limited to browsers installed on a single machine. The teachings herein can be used to control a browser on a network-connected device. This could be used to test compatibility between browsers on Apple® Macintosh® and Microsoft® Windows machines, for example. In the case of a non-local browser, some embodiments use an interactivity testing utility that receives messages from the recorder browser and applies them to the remote player.

It may be useful to display 730 and/or record 714 the sequence of events and elements they are applied to. This could be used to help debug pages or to replay a sequence at a different point in time. In some situations it can be useful to be able to record and playback interactivity for either later interrogation, or to save a script to replay on a browser to ensure compatibility from version to version. One benefit of this screen capture is to be able to display the results of a cloud browser within the same interface as a live browser. Suppose one has an embodiment that is hosting several live player browsers, and streamed video (or a sequence of screenshots) from a cloud browser. Within this interface, one can test both PC and Mac browsers, for example. Some embodiments treat a remote browser as is if it were a local live browser. There might be some latency, but instead of doing a screenshot for all remote browsers, one could transmit messages across the wire and send a screenshot of the changes back, while still interacting with a live browser.

### CONCLUSION

Although particular embodiments are expressly illustrated and described herein as methods, as configured media, or as systems, it will be appreciated that discussion of one type of embodiment also generally extends to other embodiment types. For instance, the descriptions of methods in connection with FIGS. 7 to 9 also help describe configured media, and help describe the operation of systems and manufactures like those discussed in connection with other Figures. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

As used herein, “configured to respond to the intercepted user input” and similar language does not necessarily require that a response occur. An element can be “configured to respond to user input” merely by virtue of being an intended target of user input. Thus, an element configured to respond to user input need not have an event handler registered for some user event. An embodiment may intercept an event even if the target element (the element configured to respond to the input) isn't actually going to do anything in response to the event. For example, mousing over a DIV in one browser may do nothing, whereas the same DIV in another browser has a mouse over that changes its background color. An embodiment may still intercept the event in the leader browser even if the follower browser isn't going to take an action in response to the event.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A browser interactivity recording process utilizing at least one device which has at least one logical processor, and at least one memory in operable communication with a logical processor, the process comprising the steps of automatically:
intercepting a user input to a browser;
identifying a pertinent element, namely, a Document Object Model element in the browser which is configured to respond to the intercepted user input;
creating a user-browser interaction record which specifies the identified pertinent element and the user input; and
recording the user-browser interaction record in a computer-readable storage medium.

2. The process of claim 1, wherein the intercepting step further comprises at least one of the following:
positioning a transparent window in front of a browser window to receive a user input device signal directed at the browser;
hooking a window handle for the browser;
inserting an event handler configured to intercept events caused by user input device signals, the event handler not present in an original version of the web page on a web server.

3. The process of claim 1, wherein the device has a cursor-positioning device, and the process further comprises, after identifying the pertinent element and intercepting a user input directed to the element, discarding subsequent cursor-positioning device user input until the cursor is moved outside a screen territory that is assigned to the pertinent element.

4. The process of claim 1, wherein the creating step creates a user-browser interaction record having an element ID of the pertinent element, and an action category.

5. The process of claim 1, further comprising making an association in the computer-readable storage medium which associates the user-browser interaction record with at least one of the following:
a screenshot of the browser;
a live view of the browser;
a video of the browser as multiple user inputs are applied to multiple browser Document Object Model elements;
a representation of at least a portion of a source code of the web page;
a representation of at least a portion of a Document Object Model tree of the web page.

6. A cross-browser interactivity testing system comprising:
at least one logical processor;
at least one local memory in operable communication with a logical processor;
a browser having Document Object Model elements of a web page residing in a local memory;
a cross-browser structure residing in at least one local memory, the cross- browser structure specifying a Document Object Model element and a user input; and
interactivity testing code residing in at least one local memory, the interactivity testing code (i) configured to locate, among the browser Document Object Model elements, an element corresponding to the element specified in the cross-browser structure, and (ii) configured to apply the user input to the located element.

7. The system of claim 6, wherein the cross-browser structure specifies a plurality of Document Object Model elements with corresponding user inputs, and wherein the cross-browser structure comprises the following for at least one of the Document Object Model elements: a set of attributes, a tag name of the element, an element ID attribute value, a DOM tree position of the element.

8. The system of claim 6, wherein the cross-browser structure specifies a plurality of Document Object Model elements with corresponding user inputs, and wherein the cross-browser structure comprises the following for at least one of the user inputs: an action category of the user input, a coordinate position of the user input.

9. The system of claim 6, wherein the system comprises at least one of the following:
a sequence of scripting language statements residing in a local memory, the sequence containing statements which specify Document Object Model elements and corresponding user inputs;
a sequence of statements that call methods exposed by the Document Object Model elements.

10. The system of claim 6, wherein the interactivity testing code comprises a command window, and the interactivity testing code is configured to perform at least one of the following command window operations:
logging live interactions in the cross-browser structure, namely, logging current user input and browser Document Object Model elements targeted by the user input;
making a live edit in the browser Document Object Model elements based on scripting language statements;
mimicking a user input gesture;
retrieving web page state information;
executing a command in a specified proper subset of a set of browsers which are playing back a sequence of user-browser interaction records of a cross-browser structure;
performing a record-playback command;
propagating changes in a DOM element across multiple browser instances;
propagating changes in a scripting command language variable across multiple browser instances;
forcing multiple browsers to navigate to a particular web page, thereby re-synchronizing browser interactivity.

11. The system of claim 6, wherein the interactivity testing code is configured to perform at least one of the following operations:
taking a screenshot of the browser;
recording a video of the browser as multiple user inputs are applied to multiple browser Document Object Model elements specified in the cross-browser structure
inserting marker frames in a video of the browser, thereby synchronizing a video clip with an application of user input to a Document Object Model element;
automatically freezing browser state when a specified interactivity condition is met.

12. A computer-readable non-transitory storage medium configured with data and with instructions that when executed by at least one processor causes the at least one processor to perform a process for cross-browser interactivity testing, the process comprising the steps of automatically:
reading a user-browser interaction record from a cross-browser structure, the user-browser interaction record specifying a Document Object Model element and a user input;
locating a pertinent element in a player browser, namely, a Document Object Model element in the player browser which corresponds to the element specified in the user-browser interaction record;
applying the user input to the pertinent element; and
displaying the player browser after applying the user input.

13. The configured medium of claim 12, wherein the locating and applying steps are performed for at least two player browsers, and the player browsers are displayed simultaneously after the applying steps, thereby using a single user-browser interaction record to control behavior of corresponding document elements in different browsers.

14. The configured medium of claim 13, wherein at least one of the following conditions occurs:
the locating and applying steps are performed for at least two player browsers of at least two different kinds, thereby using a single user-browser interaction record to control behavior of corresponding document elements in different kinds of browsers;
the locating and applying steps are performed for at least two player browsers on at least two machines, thereby using a single user-browser interaction record to control behavior of corresponding document elements in browsers on multiple machines.

15. The configured medium of claim 12, wherein the user-browser interaction record reading step is preceded by automatically:
intercepting a user input to a recorder browser which is a different kind of browser than the player browser;
identifying a target element, namely, a Document Object Model element in the recorder browser which is configured to respond to the intercepted user input; and
creating the user-browser interaction record from the target element and the intercepted user input.

16. The configured medium of claim 12, wherein the step of locating a pertinent element in a player browser comprises at least one of the following automatically performed steps:
determining that the player browser element has an identifying element ID attribute value that also identifies the user-browser interaction record element;
if the user-browser interaction record element has no such element ID attribute value then determining that the player browser element has an identifying DOM tree position that also identifies the user-browser interaction record element;
if the user-browser interaction record element has no such element ID attribute value then determining that the player browser element has a set of element style properties and/or attribute values that also identifies the user-browser interaction record element;
if the user-browser interaction record element has no such element ID attribute value then determining that the player browser element has a combination of element attribute values and a position with respect to viewport origin that also identifies the user-browser interaction record element.

17. The configured medium of claim 12, wherein the process further comprises at least one of the following:
interrogating a player browser Document Object Model element;
accepting a scripting language statement and in response modifying a player browser Document Object Model element;
storing the current state of player browser Document Object Model elements in a non-volatile computer-readable medium.

18. The configured medium of claim 12, wherein:
the process further comprises interpreting in a live browser each user-browser interaction record in a recorded sequence of user-browser interactions, by reading the user-browser interaction record, locating a pertinent element in a player browser, applying the user input to the pertinent element, and displaying the player browser after applying the user input; and
wherein at least one of the following conditions holds:
playback is paused, namely, the step of interpreting the sequence of user-browser interaction records is paused until a command is received to continue playback;
playback occurs in a step mode, namely, the step of interpreting each of a sequence of consecutive user-browser interaction records is triggered by a respective user command.

19. The configured medium of claim 12, wherein the process further comprises at least one of the following:
displaying a screenshot recorded from a browser illustrating an application in that browser of at least one user-browser interaction;
displaying a video clip recorded from a browser illustrating an application in that browser of multiple user-browser interactions;
animating a cursor during display of at least one image recorded from a browser illustrating an application in that browser of multiple user-browser interactions;
showing DOM tree data which is synchronized with at least one image recorded from a browser illustrating an application in that browser of at least one user-browser interaction.

20. The configured medium of claim 12, wherein the process further comprises at least one of the following:
displaying in a single screen a browser window for each of at least two browsers, thereby using limited screen space efficiently by focusing attention on currently active portions of the browsers;
receiving at the player browser multiple user-browser interaction records transmitted across a network, using the received browser interaction records to locate pertinent element(s) in the player browser, using the received user-browser interaction records to apply user inputs to the pertinent element(s), and displaying the player browser after applying at least one of the user inputs;
placing a player browser in a specified state by loading a previously stored DOM tree state rather than interpreting a sequence of user-browser interaction records to reach the specified state;
interpreting each browser interaction record in a sequence of browser interaction records, by reading the browser interaction record, locating a pertinent element in a player browser, applying the user input to the pertinent element, and displaying the player browser after applying the user input, the browser interaction records interpreted in reverse from an order in which the browser interactions were performed, thereby allowing a playback reverse mode.
